(19) United States
(12) Patent Application Publication
(10) Pub. No.: US 2009/0083616 A1
(43) Pub. Date: Mar. 26, 2009

(54) UBIQUITOUS ELECTRONIC FORMS

(75) Inventors: Alnur Ali, Kirkland, WA (US); Roberto C. Taboada, Duvall, WA (US); Pradeep K. Rasam, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/861,271

(22) Filed: Sep. 25, 2007

(51) Int. Cl. G06F 17/00

(52) U.S. Cl. 715/222

(57) ABSTRACT

Technologies are described herein for generating a ubiquitous electronic form that will function correctly in multiple execution environments. According to embodiments, a request is received to create, edit, or fill an electronic form. An input processor detects the request and, in response thereto, identifies the runtime execution environment for the requested form. Once the input processor has identified the execution environment for the electronic form, the input processor instructs a form generator to generate the electronic form for use within the identified execution environment. In response to such an instruction, the form generator generates the electronic form for use in the identified execution environment. The form generator may programmatically generate a layout for the electronic form.

### BACKGROUND

Electronic forms are formatted documents containing blank fields that can be filled in with data and are commonly utilized to request and receive information. Typically, an electronic form is displayed on a display screen. A user can fill in the form by selecting options provided by user interface controls on the form or by typing text into fields on the form. Once the user has filled the form, the user can submit the information provided in the form to a location defined by the form, such as a World Wide Web (“Web”) site.

Most electronic form creation software generates forms that are suited only for execution in one specific runtime execution environment. If the form is executed in a different execution environment, the form will likely not function correctly. For instance, traditional hypertext markup language (“HTML”) forms created for use on the Web only work correctly if they are accessed through an on-line connection to the Web site that the forms reside on. If the forms are saved to a desktop computer, sent in an electronic mail (“e-mail”) message, copied to another Web site, or utilized while off-line, the forms will most likely stop working correctly. In particular, an attempt to use a form in an execution environment for which it was not designed may cause the form to be rendered improperly, may cause submission of the form to fail, or may cause external content referenced by the form to fail to load.

One solution to the problem described above is to create a version of each form for every anticipated execution environment. This solution, however, imposes a real burden on the form designer because creating and maintaining a version of each form for every possible execution environment requires significant effort. Another solution involves programming every form to adapt to all of the possible execution environments. However, this type of brute force method for enabling forms to execute properly in multiple execution environments is very complex and costly to implement.

It is with respect to these considerations and others that the disclosure made herein is presented.

### SUMMARY

Technologies are described herein for generating a ubiquitous electronic form that will function correctly in multiple execution environments. In particular, through the utilization of the technologies and concepts presented herein, an electronic form is dynamically generated for the appropriate execution context at the time a request to create, edit, or fill the form is received. Because the electronic form is generated for the appropriate execution context at runtime, it is not necessary to create a version of the form for each execution environment in advance or to program the form to adapt to all possible execution environments. Moreover, according to embodiments, the electronic form is generated programmatically using data that defines the information to be collected by the form. In this way, it is not necessary for a form designer to create a layout for the form in advance.

According to one aspect presented herein, a request is received to fill, create, or edit an electronic form. An input processor detects the request and, in response thereto, identifies the runtime execution environment for the requested form. For instance, the execution environment for the form may be a Web browser application program that is on-line and connected to a Web site hosting the form. In another scenario, the execution environment for the form may be an e-mail client application program that may or may not be on-line. The execution environment for the form may also be a dedicated form-filling or editing application program that may be on-line or off-line. The execution environment may also be a client reader application program configured for editing a Web site at which the form is maintained. The client reader application program may be on-line or off-line. The electronic form may also be customized for use within other execution environments.

Once the input processor has identified the execution environment for the electronic form, the input processor instructs a form generator to generate the electronic form for use within the identified execution environment. In response to such an instruction, the form generator generates the electronic form for use in the identified execution environment. In particular, the form generator generates formatting data for the form that is customized for rendering within the identified execution environment. For instance, if the execution environment is a Web browser application program, the formatting data may comprise hypertext markup language (“HTML”), Asynchronous JavaScript and XML (“AJAX”), or other types of Web standard formats suitable for defining a form that may be rendered within a Web browser application program. Other types of formatting data may be utilized for other execution environments.

The form generator may also customize data within the form that defines where data collected by the form is to be submitted. For instance, if the execution environment is an on-line Web browser application program, the form may be configured to submit collected data back to the Web site hosting the form. If the execution environment is an e-mail client application program, however, the form may be customized to submit data collected by the form through an e-mail message. Other customizations may be made for other execution environments.

The form generator may also customize data within the form that references data external to the form, such as external linked images or choices for a drop-down menu. For instance, if the execution environment is an on-line Web browser application program, the external references may be maintained within the form. If the execution environment is an application program that may or may not be on-line, the externally referenced data may be incorporated into the form at the time it is generated. In this manner, the externally referenced data is available regardless of the on-line state of the execution environment.

According to another aspect, the form generator programmatically generates a layout for the electronic form. In order to accomplish this, the input processor provides the form generator with a form schema for the electronic form. The form schema defines the data fields for the electronic form and the data type for each of the specified data fields. The form generator utilizes the form schema and a mapping between data types and appropriate user interface controls for each data type to determine the user interface controls to be utilized for the form. The mapping may be pre-defined or dynamically generated. Once the user interface controls have been identified, the form generator creates the electronic form such that it can collect the desired data using the identified user interface controls. In this way, a form designer need not specify a layout for the electronic form.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a software architecture diagram illustrating aspects of the embodiments presented herein for generating electronic forms that function correctly in multiple execution environments;

FIG. 2 is a flow diagram showing an illustrative process for generating electronic forms that function correctly in multiple execution environments in one embodiment presented herein;

FIGS. 3-5 are software architecture diagrams illustrating the operation of the concepts and technologies presented herein in several illustrative execution environments;

FIG. 6 shows a table containing data identifying several illustrative customizations that may be made to an electronic form to enable the form to be used in multiple execution environments according to embodiments presented herein;

FIGS. 7-8 are software architecture and data structure diagrams, respectively, that illustrate aspects of an illustrative process provided herein for generating an electronic form using a form schema; and

FIG. 9 is a computer architecture diagram showing an illustrative computer hardware and software architecture for a computing system capable of implementing the embodiments presented herein.

### DETAILED DESCRIPTION

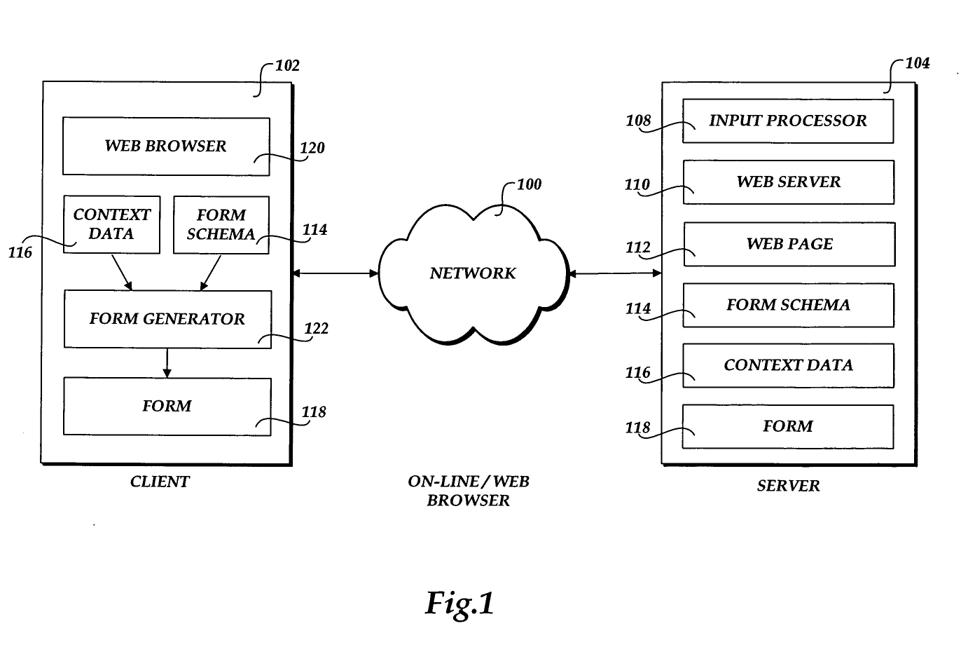

The following detailed description is directed to technologies for generating an electronic form that can function correctly in multiple execution environments. Through the utilization of the technologies and concepts presented herein, a form is generated for the intended execution environment at the time a request to create, edit, or fill the form is received. By generating the requested form at runtime in this manner, the form can be generated in a manner that ensures that it will function correctly in the intended execution environment. Additional details regarding the various embodiments presented herein for generating forms that can function correctly in multiple execution environments will be provided below with reference to FIGS. 1-9.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for generating a form that functions correctly in multiple execution environments will be provided.

Turning now to FIG. 1, an illustrative operating environment and aspects of several software components provided herein will be described. As shown in FIG. 1, one illustrative operating environment for aspects described herein includes a client computer 102 connected to a server computer 104 via a network 100. It should be appreciated that, although the embodiments presented herein are described in the context of a client computer 102 operating in conjunction with a server computer 104, the embodiments presented herein may be utilized with a standalone client computer 102, a standalone server computer 104, or in other configurations. It should also be appreciated that the network 100 may comprise any type of network suitable for connecting a client computer 102 to a server computer 104, including but not limited to a local area network (“LAN”) or a wide area network (“WAN”), such as the Internet.

As will be described in greater detail herein, the client computer 102 and the server computer 104 operate in conjunction to generate a form 118 that functions correctly in multiple execution environments. As discussed briefly above, the form 118 is a formatted document that contains fields that can be filled in with data. A user can fill in the form 118 by selecting options provided by user interface controls on the form or by typing text into fields on the form. Once a user has filled the form 118, the user can submit the information provided in the form to a location defined by the form such as the Web server 110 executing on the server computer 104.

As described in greater detail herein, the form 118 is generated in a manner that permits it to execute correctly in multiple execution environments. An execution environment generally comprises the computer program utilized to create, edit, or fill the form 118. It should be appreciated, however, that the execution environment may also include other variables, such as whether the program utilized to create, edit, or fill the form 118 is on-line and connected to the network 100 or off-line. According to other implementations, the form 118 may be rendered in a manner that takes into account other considerations than the program utilized to create, edit or fill the form and its on-line or off-line state.

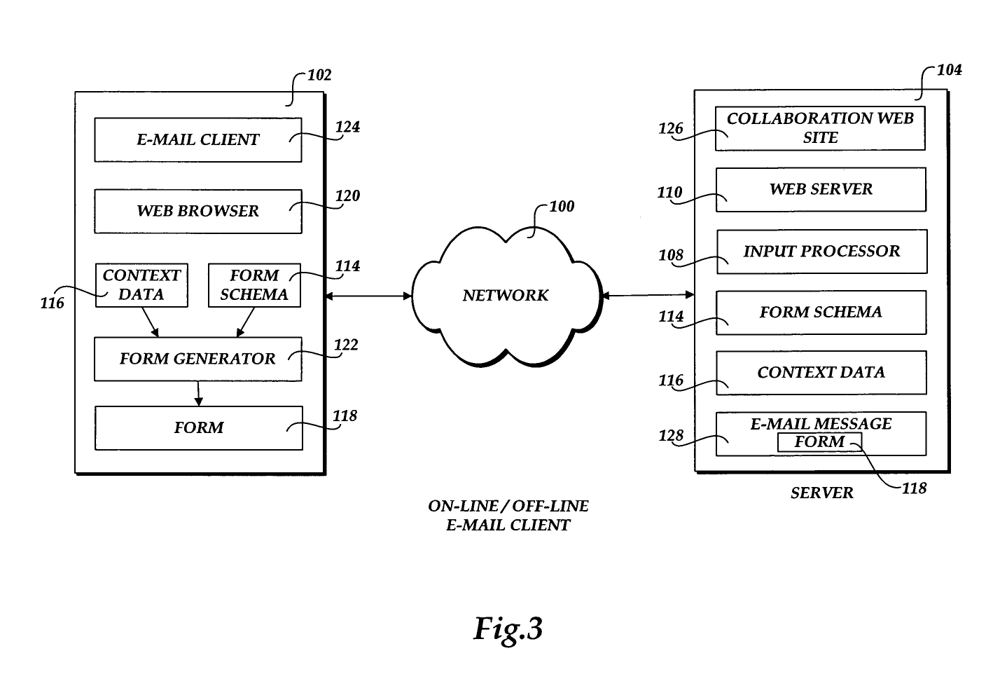

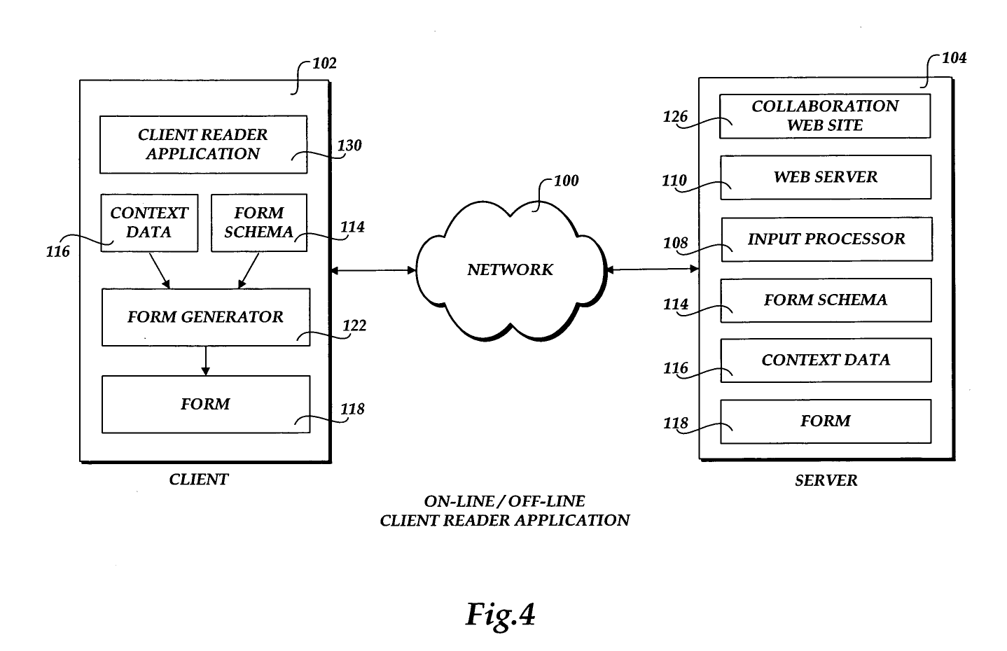

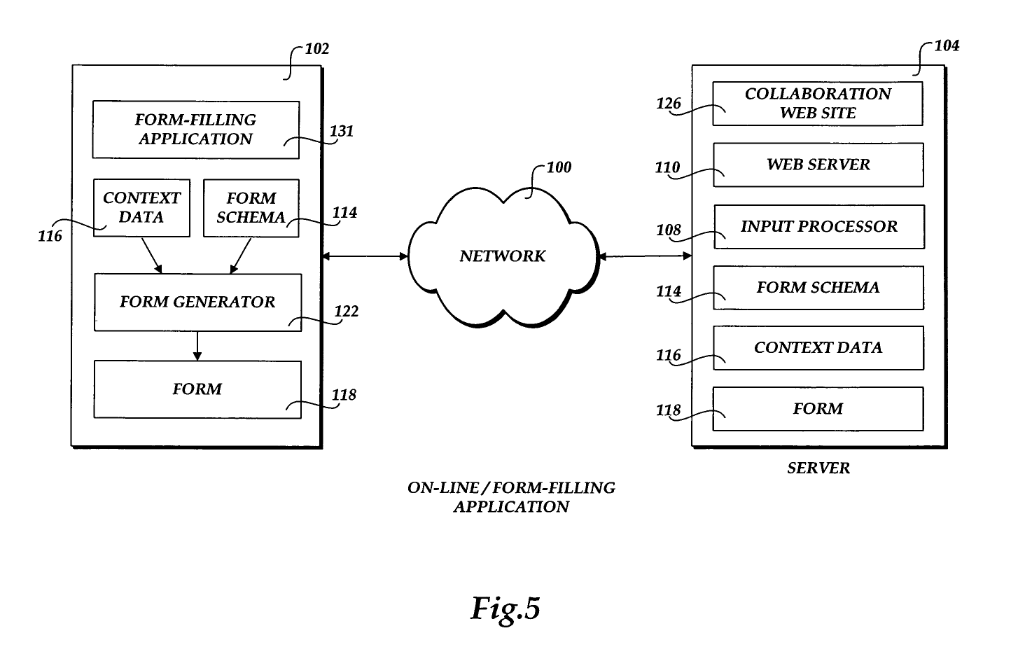

In the embodiment illustrated in FIG. 1, the execution environment for the form 118 comprises a Web browser application program 120 (a “Web browser”) that communicates with the server computer 104 via the network 100. Another execution environment wherein an electronic mail client application is utilized to fill the form 118 will be described below with reference to FIG. 3. An execution environment wherein a client reader application is utilized to create, edit, or fill the form 118 will be described below with respect to FIG. 4. Another execution environment wherein a form-filling application 130 is utilized to create, edit, or fill the form 118 will be described below with respect to FIG. 5. Other execution environments may also be utilized with the technologies and concepts presented herein.

In the embodiment shown in FIG. 1, a Web browser 120 executes on the client computer 102. A user may utilize the Web browser 120 to connect to a Web server 110 executing on the server computer 104. In particular, the Web browser 120 may be utilized to request a Web page 112 from the Web server 110 that includes a reference to a form that may be filled. Alternatively, the Web page 112 may include functionality for creating a form that may be accessed through the Web server 110.

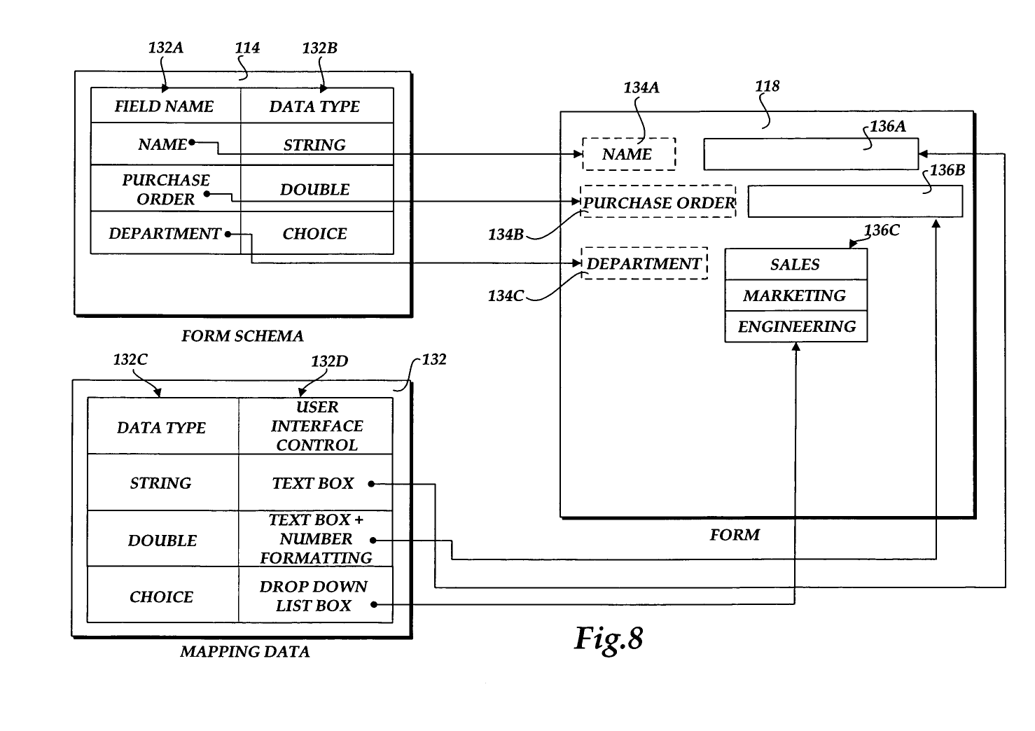

An input processor 108 executing on the server computer 104 is configured to detect a request from the Web browser 120 to fill a form or create a new form. In response to detecting such a request, the input processor 108 determines the execution environment for the requested form. In the example illustrated in FIG. 1, the execution environment comprises the Web browser 120 that is on-line and connected to the server computer 104 via the network 100. The input processor 108 also identifies a form schema 114 for the requested form. As will be described in greater detail below with respect to FIG. 8, the form schema 114 defines the data fields to be collected by the requested form and a data type for each field. The data contained in the form schema 114 is utilized by a form generator 122 executing on the client computer 102 to build the requested form. Additional details regarding this process are provided below. It should be appreciate that although the input processor 108 is shown as executing on the server computer 104, the input processor 108 may also be executed on the client computer 102 in other embodiments.

Once the input processor 108 has identified the execution environment for the requested form, data identifying the execution environment is provided to a form generator 122 in the form of context data 116. The context data 116 describes the execution environment for the requested form. The input processor 108 also provides the form schema 114 to the form generator 122. In response to receiving the context data 116 and the form schema 114, the form generator 122 generates a form 118 that collects the data identified by the form schema 114 and that is customized for the intended execution environment. For instance, in the example shown in FIG. 1, the form 118 generated by the form generator 122 is customized for rendering in the Web browser 120. Moreover, the form 118 is customized so that references to any external content are maintained, and so that data collected by the form will be published to a network location. For instance, if the form 118 references graphics or other content stored at the server computer 104, references to these items will be maintained within the generated form. If the form 118 specifies that collected data should be submitted to the Web server 110, these references will be maintained within the form 118. In this manner, the form 118 is customized for rendering within the Web browser 120 and operation within a connected network environment.

Once the form generator 122 creates the form 118, the form 118 is provided to the server computer 104. The form 118 may then be provided to the Web browser 120 as a part of the requested Web page 112. It should be appreciated that although illustrated in FIG. 1 as operating at the server computer 104, the input processor 108 may also be executed at the client computer 102. Similarly, although the form generator 122 is shown as executing on the client computer 102, the form generator 122 may also be executed at the server computer 104. Additional details regarding the process of generating the form 118 are provided below.

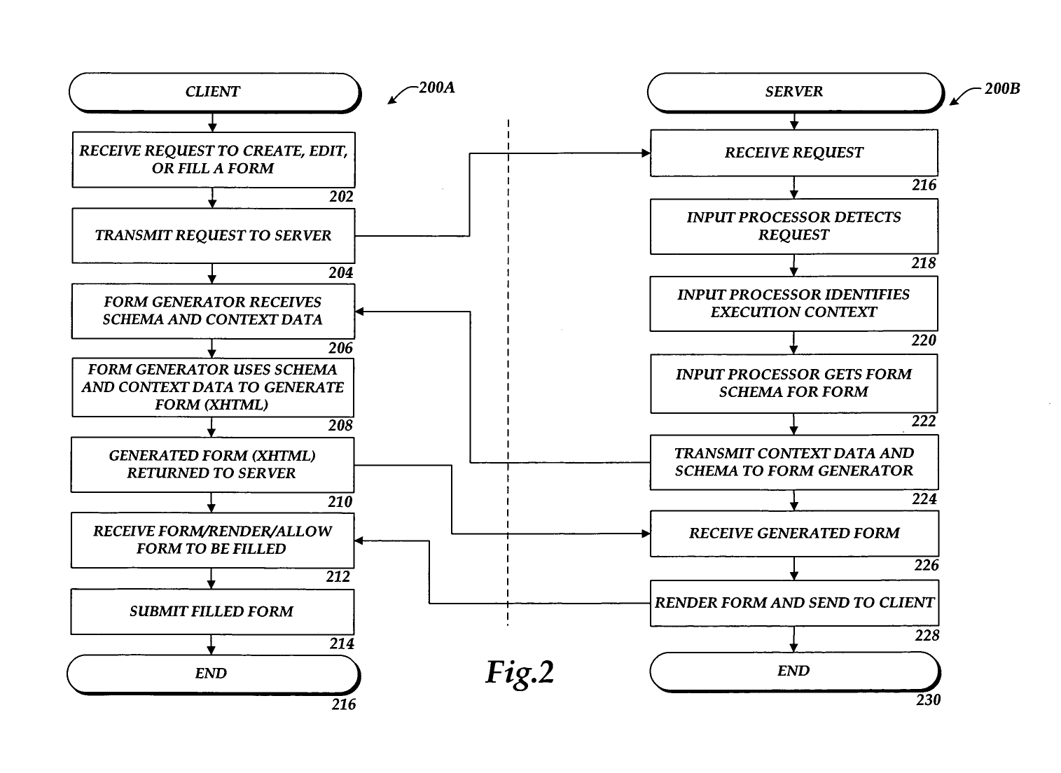

Referring now to FIG. 2, additional details will be provided regarding the embodiments presented herein for generating an electronic form that functions correctly in multiple execution environments. In particular, FIG. 2 is a flow diagram showing several routines 200A and 200B illustrating the operations of a client computer 102 and a server computer 104, respectively, for generating an electronic form in one embodiment presented herein. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 200A begins at operation 202, where a request is received at the Web browser 120 to create, edit, or fill a form. In response to receiving such a request, the routine 200A continues to operation 204, where the request is transmitted to the server computer 104. The server computer 104 receives the request at the operation 216 of the routine 200B. From operation 216, the routine 200B continues to operation 218, where the input processor 108 detects the form request. In response to detecting the form request, the input processor 108 identifies the execution context for the requested form. This occurs at operation 220. As described above, identifying the execution context may include identifying the computer program utilized to create, edit, or fill the requested form and whether the computer program is expected to be on-line or off-line.

From operation 220, the routine 200B continues to operation 222 where the input processor 108 obtains the form schema 114 for the requested form. As discussed briefly above, the form schema 114 includes data that identifies the data fields to be included in the requested form and a data type for each field. As will be discussed below with respect to FIG. 8, the form schema 114 is utilized by the form generator 122 to programmatically create the requested form. Once the execution environment for the requested form and the appropriate form schema 114 have been identified, context data 116 identifying the execution context and the form schema 114 are transmitted to the form generator 122. This occurs at operation 224.

At operation 206 of the routine 200A, the form generator 122 receives the context data 116 and the form schema 114. The routine 200A then continues to operation 208, where the form generator 122 utilizes the context data 116 and the form schema 114 to generate the requested form 118. In one implementation, the form generator 122 generates a form 118 that is expressed utilizing extensible mark-up language hypertext mark-up language (“XHTML”). XHTML is a mark-up language that has the same depth of expression as HTML, but also conforms to extensible mark-up language (“XML”) syntax. At operation 210, the generated form is returned to the server computer 104.

At operation 226 of the routine 200B, the server computer 104 receives the generated form 118. In one implementation, the XHMTL version of the form is rendered into HTML or another format suitable for rendering within the identified execution environment. For instance, wherein the execution environment includes a Web browser 120, AJAX or other types of Web standard formats suitable for defining a form that may be rendered within the Web browser 120 may be utilized. The form 118 is rendered in this manner at operation 228 and returned to the client computer 102.

At operation 212 of the routine 200A, the Web browser 120 receives the form 118 and renders the form for creation, editing, or filling by a user. The Web browser 120 then allows the user to interact with the form, including filling in the various fields of the form. Once a user has completed their interaction, they may request that the filled form 118 be submitted back to the Web server 110. This occurs at operation 214. The routines 200A and 200B end at operations 216 and 230, respectively. Additional details regarding the operations for generating a form that executes correctly in multiple execution environments are provided below with respect to FIGS. 3-5.

Referring now to FIG. 3, aspects of the creation of a form 118 within another execution environment will be described. In particular, FIG. 3 illustrates an execution environment that includes an e-mail client 124 (“e-mail client”). The e-mail client 124 may or may not be on-line and connection to the network 100. Accordingly, in this embodiment, the form 118 is created in a manner that takes into account the possibility that the e-mail client 124 may be on-line or off-line at the time the form is created and at the time data collected by the form is submitted.

In the embodiment shown in FIG. 3, the Web browser 120 is utilized to request a page on a collaboration Web site 126 provided by the Web server 110 that provides functionality for creating an e-mail form. An e-mail form is a form that can be rendered by an e-mail client 124. Data collected by the form is submitted via a return e-mail message. In one implementation, the collaboration Web site 126 comprises a Web site created by the MICROSOFT OFFICE SHAREPOINT SERVER from MICROSOFT CORPORATION of Redmond, Wash. It should be appreciated, however, that other types of Web sites may be utilized to create electronic mail forms.

In a similar manner as described above with reference to FIG. 1, the input processor 108 detects the request to create the new form. In response to detecting the request to create the form, the input processor 108 identifies the intended execution environment for the form. In the embodiment shown in FIG. 3, the intended execution environment is within the e-mail client 124, which may or may not be connected to the network 100. The input processor 108 also identifies the appropriate form schema 114 for the requested form. Once these items have been identified, the input processor 108 transmits the form schema 114 and context data 116 identifying the execution environment to the form generator 122.

In a manner similar to that described above with respect to FIG. 1, the form generator 122 then utilizes the context data 116 and the form schema 114 to generate a form 118 suitable for use within the identified execution environment. In particular, the form 118 generated by the form generator 122 in this implementation is configured for rendering within the e-mail client 124, any external data referenced by the form is integrated into the form itself, and the form is configured so that data collected by the form will be submitted via an electronic mail message. In this manner, the form may be correctly rendered by the e-mail client and data collected by the form may be properly submitted regardless of whether the e-mail client application is on-line or off-line.

Once the form generator 122 has completed creation of the form 118, the form 118 is returned to the server computer 104. The form 118 is then integrated into an e-mail message 128 and transmitted to the e-mail client 124. The e-mail client 124 can then render the e-mail message 128 and the form 118. A user may be permitted to enter data in the form and submit the form via a return e-mail message.

Turning now to FIG. 4, another embodiment presented herein in which the execution environment includes a client reader application 130 will be described. The client reader application 130 comprises an application program configured for off-line editing of the collaboration Web site 126. In one particular implementation, the client reader application 130 comprises the MICROSOFT OFFICE GROOVE client reader application from MICROSOFT CORPORATION of Redmond, Wash. It should be appreciated, however, that other types of client reader applications from other manufacturers may also be utilized.

In the embodiment shown in FIG. 4, the client reader application 130 is utilized to edit a page of the collaboration Web site 126 that includes a form. In response to detecting such a request, the input processor 108 identifies the execution context for the requested form. In the example shown in FIG. 4, the execution context comprises the client reader application 130, which may or may not be on-line and connected to the network 100. The input processor 108 also identifies an appropriate form schema 114 for the requested form. The input processor 108 provides the form schema 114 and context data 116 identifying the execution environment to the form generator 122.

The form generator 122 utilizes the form schema 114 and the context data 116 to generate a form that is suitable for rendering by and use within the client reader application 130. In particular, the form 118 is formatted such that any data external to the form is integrated into the form itself and such that any data collected by the form is submitted to the client reader application 130. In this manner, the client reader application 130 gates data submitted by the form to the collaboration Web site 126. Once the form generator 122 has completed generation of the form 118, the form is returned to the server computer 104. The form may then be provided to the client reader application 130.

Referring now to FIG. 5, an execution environment that includes a form-filling application program 131 will be described. The form-filling application program 131 comprises a computer program that is configured to allow the creation, editing, and filling of an electronic form. For instance, in one implementation, the form-filling application program 131 comprises the MICROSOFT OFFICE INFOPATH form creation and filling application program from MICROSOFT CORPORATION. Other form-filling application programs may include the ADOBE ACROBAT series of form-filling and creation programs from ADOBE CORPORATION. It should be appreciated that the form-filling application program 131 may be on-line and connected to the network 100 or off-line.

In the embodiment shown in FIG. 5, the form-filling application program 131 communicates with the Web server 110 to request a page of the collaboration Web site 126 that includes a form. The input processor 108 is configured to detect such a request and to identify the intended execution environment for the requested form in response thereto. In the example shown in FIG. 5, the execution environment for the requested form is the form-filling application program 131, which may or may not be on-line and connected to the server computer 104. The input processor 108 also identifies the appropriate form schema 114 for the requested form. Once the execution context and form schema 114 have been identified, the input processor 108 provides the form schema 114 and context data describing the intended execution environment to the form generator 122.

The form generator 122 utilizes the context data 116 and the form schema 114 to generate a form 118 that is suitable for use within the form-filling application program 131. In particular, the form 118 is created for rendering within the form-filling application program 131, and any data referenced externally by the form is incorporated into the form itself. Submissions of data collected by the form are configured for submission to the server computer 104. Once the form 118 has been created by the form generator 122, the form is returned to the server computer 104. The form 118 may then be returned to the form-filling application program 131 for filling by a user.

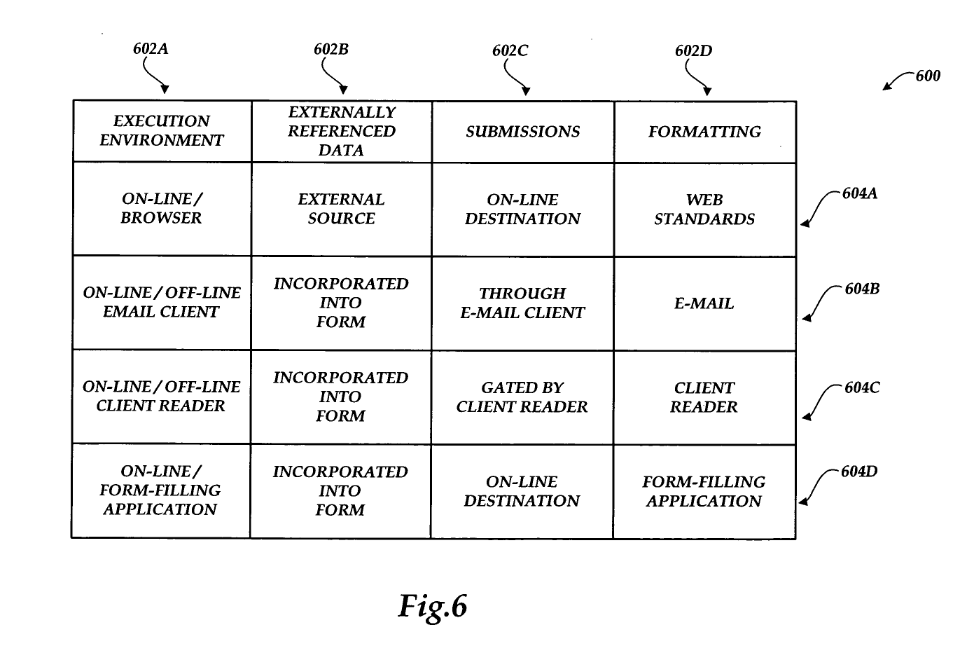

Referring now to FIG. 6, a table 600 will be described that summarizes aspects of the operation of the form generator 122 for customizing a form 118 for a particular execution environment. In particular, the column 602A of the table 600 identifies the various execution environments for which the form generator 122 may create a form in one embodiment. The row 604A corresponds to an execution environment that includes a Web browser 120 that is on-line and connected to the network 100. The row 604B corresponds to the embodiment discussed above with respect to FIG. 3 where the execution environment includes an e-mail client 124 that may be on-line or off-line. The row 604C corresponds to the embodiment discussed above with respect to FIG. 4 where a client reader application 130 is utilized that may be on-line or off-line. Finally, row 604D corresponds to the embodiment described above with respect to FIG. 5 where a form-filling application program 131 is utilized that is considered to be on-line and connected to the network 100.

The column 602B identifies how externally referenced data is treated by the form generator 122 in each of the specified execution environments. As a general matter, if the computer program utilized to create, edit, or fill the form is assumed to be on-line and connected to the network 100, externally referenced data is maintained in its network location. If, however, the computer program utilized to create, edit, or fill the form may be off-line, any externally referenced data is incorporated into the form by the form generator 122. In this manner, any externally referenced data would be rendered correctly within the form 118 regardless of the on-line or off-line state of the computer program utilized to create, edit, or fill the form.

The column 602C indicates how the form generator 122 handles the submission of data collected by the form. As described above, when a Web browser application program 120 it utilized that is on-line, any data collected by the form is submitted to its identified on-line destination. Where an e-mail client application is utilized that may or may not be connected to the network 100, the e-mail client 124 itself is utilized to submit data collected by the form to its intended destination. When a client-reader application 130 is utilized, submissions by the form are gated by the client reader application 130. In this manner, data can be collected while the client reader application 130 is off-line and later submitted to its intended destination when the client reader application 130 comes on-line. Data submitted through a form-filling application program 131 that is on-line and connected to the network 100 is configured for submission to its intended on-line destination.

The column 602D identifies how the form generator 122 formats the form 118 for rendering within the intended execution environment. In the case of a Web browser 120, XML, AJAX, and other Web standards may be utilized for rendering by the Web browser application program 120 or other type of application program configured to render such standards. When the execution environment comprises an e-mail client 124, the form generator 122 customizes the form for rendering by the e-mail client 124. In many cases, the e-mail client 124 may be capable of rendering typical Web standards, such as HTML. When the execution environment comprises the client reader application 130, the form generator 122 configures the form for rendering by the client reader application 130. Similarly, when the execution environment includes the client reader application 130, the form generator 122 configures the form for rendering by the client reader application 130. Similarly, when the execution environment includes the form-filling application program 131, the form generator 122 renders the form 118 in a manner such that it may be rendered by the form-filling application program 131.

It should be appreciated that the customizations illustrated in FIG. 6 are merely illustrative. It should further be appreciated that other types of customizations may be performed for the illustrative execution contexts described herein. It should also be appreciated that the execution contexts presented herein are merely illustrative and other types of execution contexts may be utilized with the technologies and concepts presented herein.

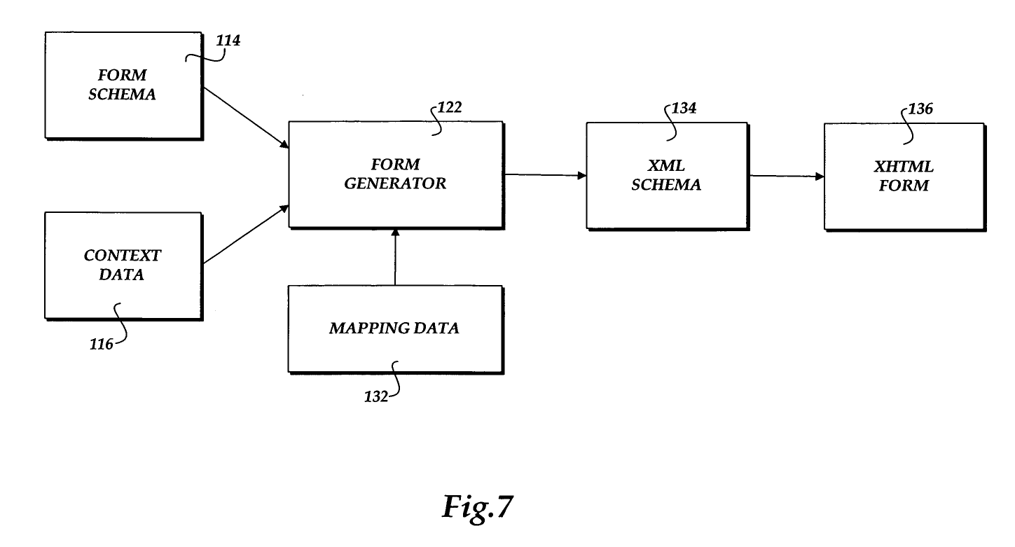

Referring now to FIG. 7, additional details regarding one process utilized by the form generator 122 to generate the form 118 will be described. As mentioned above, the form generator 122 utilizes the form schema 114 and context data 116 that describes the intended execution environment to generate the requested form. In this regard, the form generator 122 also utilizes mapping data 132 that maps particular data types to user interface controls to be placed on the form. For instance, if the form schema 114 indicates that a string is to be collected, and the mapping data 132 indicates that a text box user interface control is to be utilized for collecting string data, the form generator 122 will place an appropriate text box user interface control onto the form 118. The form generator 122 processes the fields identified by the form schema 114 sequentially in this manner to place the appropriate user interface controls for collecting the data identified by the form schema 114 on the form 118.

In one implementation, the form generator 122 outputs a proper XML schema 134 for the created form. The XML schema 134 can then be processed to create an XHMTL form 136. The XHTML form 136 can then be processed to incorporate appropriate formatting for the intended execution environment, such as HTML. Additional details regarding the use of the form schema 114 and the mapping data 132 to generate the appropriate user interface controls on the form 118 will be provided below with respect to FIG. 8.

It should be appreciated that, in one implementation, the mapping data 132 comprises a pre-defined and stored mapping between data types and user interface controls (as shown in FIG. 8, below). However, the mapping data 132 may also be dynamically generated by inferring the most appropriate user interface control to utilize based on the data type of the data to be collected. For instance, frequency data may be maintained that describes the frequency with which various user interface controls are utilized to collect data of different data types. The particular user interface control to utilize for collecting data of a particular data type may be identified through the use of such data.

Referring now to FIG. 8, additional details regarding one process performed by the form generator 122 for generating the form 118 will be described. As mentioned above, the form schema 114 includes a data field 132A identifying a field name for each of the fields that to be included on the form 118. For each field name identified in the data field 132A, the data field 132B identifies a corresponding data type. For instance, in the example form schema 114 shown in FIG. 8, a “name” field is identified in the form schema 114 that has a string data type. A “purchase order” field is identified that has a double integer data type, and a “department” field is identified that has a choice data type. A choice data type is appropriate where multiple but finite choices may be provided to the user in the form of a drop-down menu or other suitable user interface control.

FIG. 8 also shows the contents of an illustrative mapping data 132. As discussed above, the mapping data 132 includes a data type field 132C and a user interface control field 132D. In this manner, the mapping data 132 identifies the appropriate user interface control to be utilized for each data type. For instance, in the illustrative mapping data 132 shown in FIG. 8, a text box user interface control is specified for string data, a text box control that includes number formatting is specified for a double integer data type, and a drop-down user interface control list box is specified for choice data.

During the generation of a form 118, the form generator 122 consults both the form schema 114 and the mapping data 132. For instance, in the illustrative example shown in FIG. 8, labels 134A-134C are created that correspond to each of the field names specified in the data field column 132A. The form generator 122 would also identify the appropriate data type as specified in the data field 132B for each of the specified fields. The mapping data 132 is consulted to identify the appropriate user interface controls 136A-136C for each of the fields specified by the form schema 114. Each of these controls is then added to the form 118. For instance, a text box user interface control 136A would be placed on the form 118 for collecting string data, a text box user interface control 136B with number formatting would be placed on the form 118 for collecting the double integer data, and the drop-down control user interface control 136C will be placed on the form 118 for collecting the choice data.

It should be appreciated that, by generating the form 118 in the manner presented herein, it is unnecessary for a form designer to specify a layout for the form 118. Rather, only the names of each of the fields and the data type to be collected by each of the fields need be specified. The form generator 122 can programmatically create a form 118 that includes the appropriate user interface controls and that is properly formatted for use within the intended execution environment. It should also be appreciated that by identifying the intended execution environment for the form 118 at the time a request is received to create, edit, or fill the form 118, the form can be created in a manner that permits correct execution within the intended execution environment.

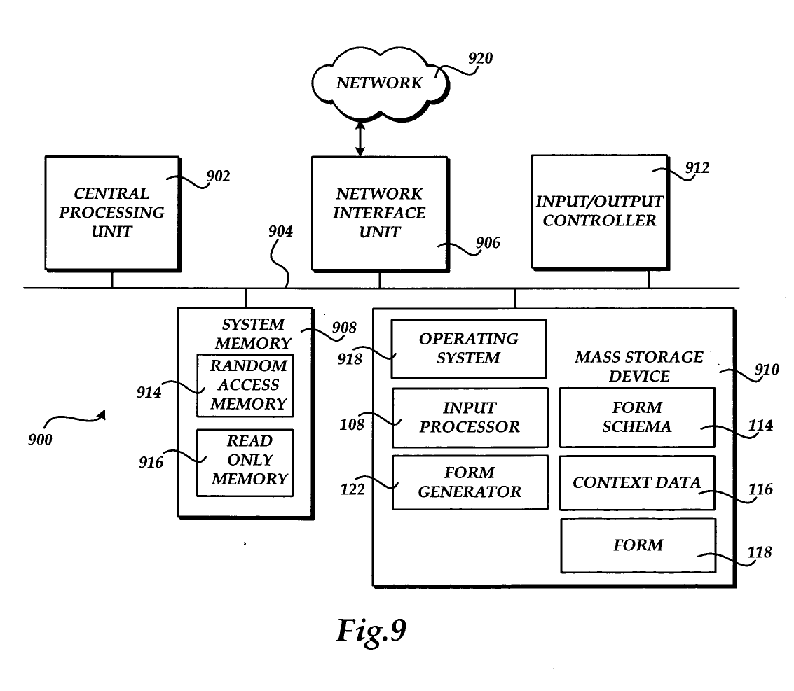

FIG. 9 shows an illustrative computer architecture for a computer 900 capable of executing the software components described herein for generating an electronic form that functions correctly in multiple execution environments. The computer architecture shown in FIG. 9 illustrates a conventional desktop, laptop, or server computer and may be utilized to embody the client computer 102 or the server computer 104 and to execute some or all of the software components described herein.

The computer architecture shown in FIG. 9 includes a central processing unit 902 (“CPU”), a system memory 908, including a random access memory 914 (“RAM”) and a read-only memory (“ROM”) 916, and a system bus 904 that couples the memory to the CPU 902. A basic input/output system containing the basic routines that help to transfer information between elements within the computer 900, such as during startup, is stored in the ROM 916. The computer 900 further includes a mass storage device 910 for storing an operating system 918, application programs, and other program modules, which are described in greater detail herein.

The mass storage device 910 is connected to the CPU 902 through a mass storage controller (not shown) connected to the bus 904. The mass storage device 910 and its associated computer-readable media provide non-volatile storage for the computer 900. Although the description of computer-readable media contained herein refers to a mass storage device, such as a hard disk or CD-ROM drive, it should be appreciated by those skilled in the art that computer-readable media can be any available computer storage media that can be accessed by the computer 900.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 900.

According to various embodiments, the computer 900 may operate in a networked environment using logical connections to remote computers through a network such as the network 920. The computer 900 may connect to the network 920 through a network interface unit 906 connected to the bus 904. It should be appreciated that the network interface unit 906 may also be utilized to connect to other types of networks and remote computer systems. The computer 900 may also include an input/output controller 912 for receiving and processing input from a number of other devices, including a keyboard, mouse, or electronic stylus (not shown in FIG. 9). Similarly, an input/output controller may provide output to a display screen, a printer, or other type of output device (also not shown in FIG. 9).

As mentioned briefly above, a number of program modules and data files may be stored in the mass storage device 910 and RAM 914 of the computer 900, including an operating system 918 suitable for controlling the operation of a networked desktop, laptop, or server computer. The mass storage device 910 and RAM 914 may also store one or more program modules. In particular, the mass storage device 910 and the RAM 914 may store the input processor 108, the form generator 122, the form schema 114, the context data 116, and the form 118, each of which have been described above. The mass storage device 910 and the RAM 914 may also store other program modules.

It should be appreciated that, in other embodiments, a form may be created that has the capability to cross execution environments while still retaining its functionality. In this implementation, a form is generated in the manner described above for a first execution context. If the form is moved to a second execution context, the form can sense that the execution environment has been changed and modify its references to external data, the manner in which it is rendered, and the location for submission of data collected by the form.

Based on the foregoing, it should be appreciated that technologies for generating a ubiquitous electronic form that can function correctly in multiple execution environments are disclosed herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments illustrated and described, and without departing from the spirit and scope of the present invention, which is set forth in the following claims.

What is claimed is:

1. A method for generating an electronic form that functions correctly in multiple execution environments, the method comprising:
receiving a form request;
in response to receiving the form request, identifying an execution environment for the electronic form when the form request is received;
generating an electronic form for use within the identified execution environment; and
providing the generated form in response to the received form request.

2. The method of claim 1, wherein the form request comprises a request to fill the electronic form.

3. The method of claim 1, wherein the form request comprises a request to create the electronic form.

4. The method of claim 1, wherein generating an electronic form for use within the identified execution environment comprises:
retrieving a schema for the electronic form that defines one or more data fields for the electronic form and data types for the data fields;
retrieving a mapping that defines one or more user interface controls to be utilized for each of the data types;
identifying one or more user interface controls to be utilized in the electronic form using the schema and the mapping; and
generating the electronic form having the identified user interface controls.

5. The method of claim 1, wherein the electronic form comprises formatting data defining how the electronic form is to be rendered, and wherein generating an electronic form for use within the identified execution environment comprises generating the formatting data for the identified execution environment.

6. The method of claim 5, wherein the electronic form further comprises submission data defining where data collected by the electronic form is to be submitted, and wherein generating an electronic form for use within the identified execution environment further comprises generating the submission data for the identified execution environment.

7. The method of claim 6, wherein the electronic form further comprises one or more references to data external to the electronic form, and wherein generating an electronic form for use within the identified execution environment further comprises generating the references to data external to the electronic form for the identified execution environment.

8. A system for generating an electronic form that functions correctly in multiple execution environments, the system comprising:
an input processor configured to detect a form request, to identify an execution environment for the electronic form when the form request is detected, and to provide an instruction to a form generator to generate an electronic form for use in the identified execution environment; and
a form generator configured to receive the instruction from the input processor and, in response to receiving the instruction, to generate an electronic form for use in the identified execution environment and to provide the generated electronic form in response to the form request.

9. The system of claim 8, further comprising:
a schema for the electronic form that defines one or more data fields for the form and data types for the data fields; and
a mapping that defines user interface controls to be utilized for each of the data types, and wherein the form generator is further operative to generate an electronic form for use in the identified execution environment by identifying the user interface controls to be utilized in the form using the schema and the mapping, and generating the electronic form having the identified user interface controls.

10. The system of claim 9, wherein the execution environment comprises an on-line World Wide Web browser application program.

11. The system of claim 9, wherein the execution environment comprises en electronic mail client application program.

12. The system of claim 9, wherein the execution environment comprises a client reader application program.

13. The system of claim 9, wherein the execution environment comprises a form-filling application program.

14. The system of claim 9, wherein the form request comprises a request to fill the electronic form.

15. The system of claim 9, wherein the form request comprises a request to create the electronic form.

16. A computer-readable medium having computer-executable instructions stored thereon which, when executed by a computer, will cause the computer to:
detect a request to create or edit an electronic form;
identify a runtime execution environment for the electronic form when the request is detected;
generate the electronic form for use within the identified execution environment; and to provide the generated electronic form in response to the detected request.

17. The computer-readable medium of claim 16, wherein the electronic form comprises formatting data defining how the electronic form is to be rendered in the identified execution environment, and wherein generating the electronic form for use within the identified execution environment comprises generating the formatting data for the identified execution environment.

18. The computer-readable medium of claim 17, wherein the electronic form further comprises submission data defining where data collected by the electronic form is to be submitted, and wherein generating the electronic form for use within the identified execution environment further comprises generating the submission data for the identified execution environment.

19. The computer-readable medium of claim 18, wherein the electronic form further comprises one or more references to data external to the electronic form, and wherein generating the electronic form for use within the identified execution environment further comprises generating the references to data external to the electronic form for the identified execution environment.

20. The computer-readable medium of claim 19, wherein the operation to generate the electronic form for use within the identified execution environment comprises:
retrieving a schema for the electronic form that defines one or more data fields for the form and data types for the data fields;
retrieving a mapping that defines one or more user interface controls to be utilized for each of the data types;
identifying one or more user interface controls to be utilized in the form using the schema and the mapping; and
generating the electronic form having the identified user interface controls.
